(19) United States
(12) Patent Application Publication
(10) Pub. No.: US 2009/0177660 A1
(43) Pub. Date: Jul. 9, 2009

(54) DOCUMENT MANAGING SYSTEM, INFORMATION PROCESSING DEVICE, DOCUMENT MANAGING METHOD, AND PROGRAM

(76) Inventor: HIDETOSHI ITOU, Tokyo (JP)

Correspondence Address: NEC CORPORATION OF AMERICA, 6535 N. STATE HWY 161, IRVING, TX, 75039, US

(21) Appl. No.: 12/350,408

(22) Filed: Jan. 8, 2009

(30) Foreign Application Priority Data
Jan. 8, 2008 (JP) 2008.001538

(51) Int. Cl. G06F 17/30

(52) U.S. Cl. 707/9; 707/E17.008

(57) ABSTRACT

An optical document managing server determines whether or not an access authority for accessing a document under its management is within a valid period preset on a per entry unit when receiving an access request for accessing the document from a client terminal, and permits access to the document when the access authority is within the valid period. This enables automatic access control for only limited users in access authority functions.

This application is based upon and claims the benefit of priority from Japanese patent application No. 2008-001538, filed on Jan. 8, 2008, the disclosure of which is incorporated herein in its entirety by reference.

### BACKGROUND OF THE INVENTION

1. Field of the Invention

The present invention relates to a technology that manages a document having, for example, an access authority function with valid period/fixed-term.

2. Description of Related Art

In recent years, corporation ware is provided which is a common workspace over the border of organizations in a company, and its request is also expanded. In association therewith, there is needed more flexible and convenient access control in a document managing system.

There has been suggested a technology as a related art, which may easily grasp the summary of document information to swiftly contact the register of the document information by email and the like. In the construction, an information acquisition device receives summary information and displays the brief information included in the summary information. If a document information acquisition request is given, it is determined from current date and valid period information included in the summary information whether the document information corresponding to the received summary information is within the valid period or not. If the document information is within the valid period, corresponding document information is acquired from a database. If the document information is not within the valid period, a contact document is created and transmitted to an information registering device that registered the document information. In this connection, there has been known the one disclosed, for example, in Japanese Patent Application Laid-Open (JP-A) No. 2003-345635 (patent document 1).

Also, there has been suggested a technology as a related art, which may manage document information based on its validity. In the construction, valid period information inputted from a document management information input device is added to document management information of the corresponding document that has been recorded in a document management information recording device. When there is made an access request to the document information recorded in the document information recording device based the searching information inputted from the document management information input device, it is determined whether the access request is valid or invalid based on the valid period information added to the document data. Based on the determined result, there is rejected an access request to the document information that has been determined to be invalid. In this connection, there has been known the one disclosed, for example, in JP-A No. H8-328922 (patent document 2).

Next, problems with the related arts will be described.

The related arts respectively include a structure of simply setting a valid period for the entire document independently from an access authority. The attribute of “valid period/period” is used to be independent from the access authority, and also used as an attribute having stronger authority than the access authority. Therefore, there has existed a problem in that if the valid period expires, the whole users other than a manager, register, or updater may not gain access irrespective of preset values of the access authority.

### SUMMARY

The present invention has been designed to solve the above problem. Accordingly, an exemplary object of the present invention is to provide a document managing system, an information processing device, a document managing method, and a program that automatically perform access control with respect to only limited users in an access authority function that is generally used in a document managing system.

[Document Managing System]

To accomplish the exemplary object, a document managing system according to a first exemplary aspect of the present invention, having a document managing server and a client terminal that are connected to each other over via network, is characterized in that the document managing server determines whether or not an access authority for accessing a document under its management is within a valid period preset on a per entry unit when receiving an access request for accessing the document from the client terminal, and permits access to the document when the access authority is within the valid period.

[Information Processing Device]

An information processing device according to a second exemplary aspect of the present invention determines whether or not an access authority for accessing a document is within a valid period preset on a per entry unit when receiving an access request for accessing the document, and permits access to the document when the access authority is within the valid period.

[Document Managing Method]

A document managing method according to a third exemplary aspect of the present invention includes receiving an access request for accessing a document; determining whether or not an access authority for accessing the document is within a valid period preset on a per entry unit; and permitting access to the document if the access authority is within the valid period.

[Program]

A program according to a fourth exemplary aspect of the present invention, causes a information processing device to execute process including receiving an access request for accessing a document; determining whether or not an access authority for accessing the document is within a valid period preset on a per entry unit; and permitting access to the document if the access authority is within the valid period.

### BRIEF DESCRIPTION OF THE DRAWINGS

FIG. 1 is a view illustrating a system construction according to an exemplary embodiment of the present invention;

FIG. 2 is a functional block diagram illustrating a document managing server according to the exemplary embodiment of the present invention;

FIG. 3 is a view illustrating a data structure at an authentication server according to the exemplary embodiment of the present invention;

FIG. 4 is a flowchart illustrating an entire operation of the system according to the exemplary embodiment of the present invention;

FIG. 5 is a view illustrating an example of a data structure of an access authority according to the exemplary embodiment of the present invention; and

FIG. 6 is a view illustrating an example of a process operation according to the exemplary embodiment of the present invention.

### EXEMPLARY EMBODIMENT

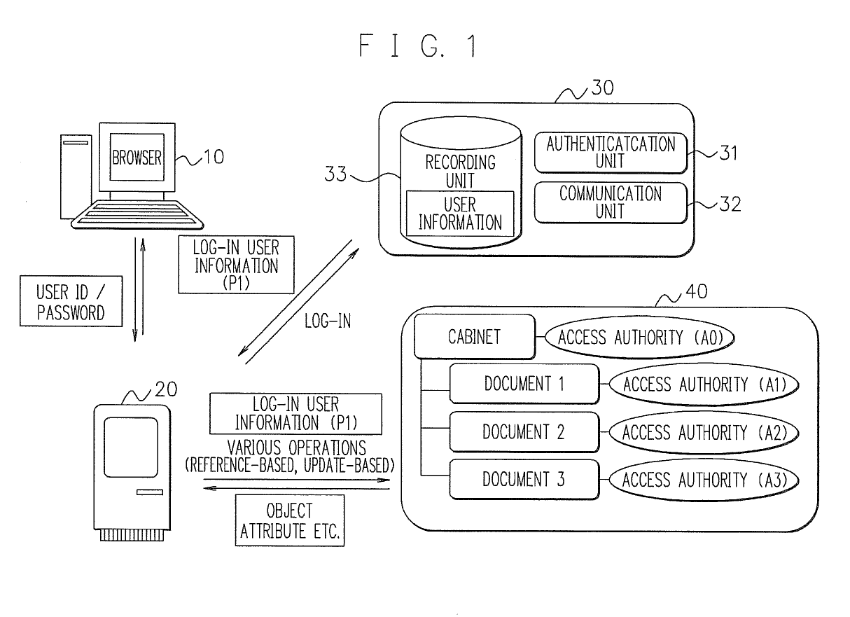

Hereinafter, a first exemplary embodiment of the present invention will be described in more detail with reference to accompanying drawings. A document managing system according to an exemplary embodiment shown in FIG. 1 includes a client terminal 10, a Web server 20, an authentication server 30, and a document managing server 40. Each server is an information processing device such as a workstation. Also, the document managing system herein includes, but is not limited to, a system that is used in the general in-house Intranet.

Each client terminal 10 is an information processing device such as a personal computer or mobile terminal that is an individual user terminal. Each client terminal 10 gains access to the Web server 20 through a browser, performs user authentication and log-in by the authentication server 30 <UD1>, and then uses data in the document managing server 40. At the same time with log-in, the client terminal 10 obtains personal information (P1) of the log-in user from the authentication server 30. The authentication server 30 includes an authentication unit 31 that performs an authentication process, a communication unit 32, and a recording unit 33 that stores user's information. The structure of data and the flow of the authentication process managed by the authentication server 30 will be described later in the descriptions on operations according to the exemplary embodiments.

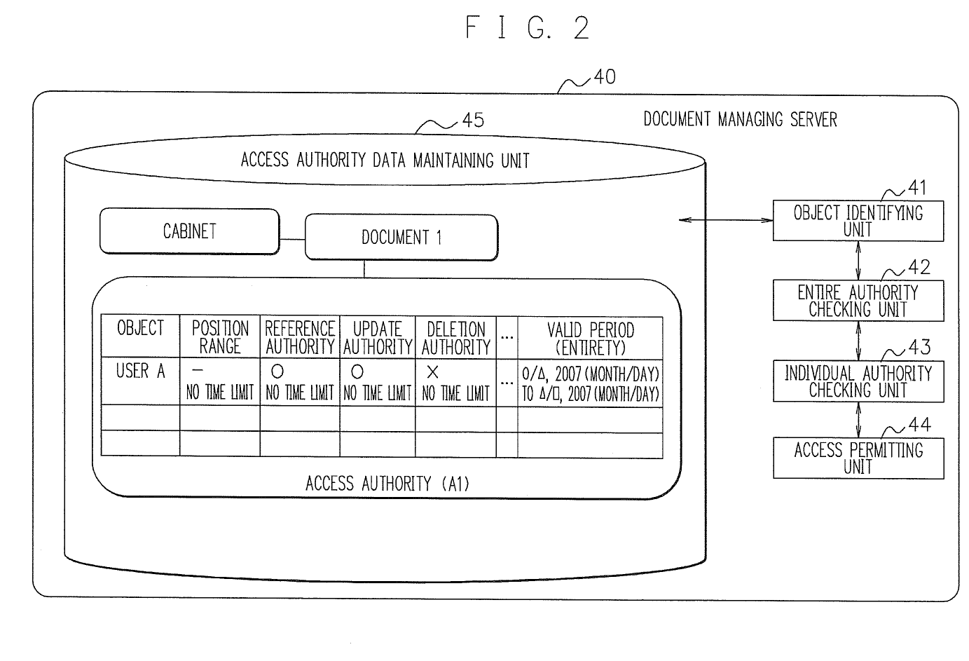

The document managing server 40 performs an access authority check on a targeted object based on the user personal information (P1) obtained through the user authentication. As shown in FIG. 2, the document managing server 40 includes an object identifying unit 41, an entire authority checking unit 42, an individual authority checking unit 43, an access permitting unit 44, and an access authority data maintaining unit 45.

The object identifying unit 41 includes a function of identifying whether there exists an access-requested object. The entire authority checking unit 42 includes a function of determining whether each access authority entry is within a valid period or not. The individual authority checking unit 43 includes a function of sequentially determining with respect to valid access authority entries whether an individual authority is within the valid period or not. The access permitting unit 44 includes a function of permitting access to an object in a case where it is determined to be within the valid period by the authority check. The access authority data maintaining unit 45 is a database that includes a predetermined table that records access authority data.

Data structures and access authority checking methods of the access authority data maintaining unit 45 on the document managing server 40 side will be described in the descriptions on the operations according to the exemplary embodiment.

It is assumed in the exemplary embodiments that “cabinet” is included in the document managing server 40 and file groups, such as “document 1”, “document 2”, and “document 3”, are included under the “cabinet”. Also, it is assumed that access authority information A1 is registered in the “document 1” (which is the same for other objects). The access authority information will be also described in the descriptions on the operations according to the exemplary embodiments.

Hereinafter, the operation according to the exemplary embodiment will be described in more detail with reference to accompanying drawings. The document managing system according to the exemplary embodiment may perform flexible access control according to each utilization aspect by enabling valid periods to be combined with and set on a per-access authority entry unit while the access authority is checked by the document managing server 40 side.

(User Authentication)

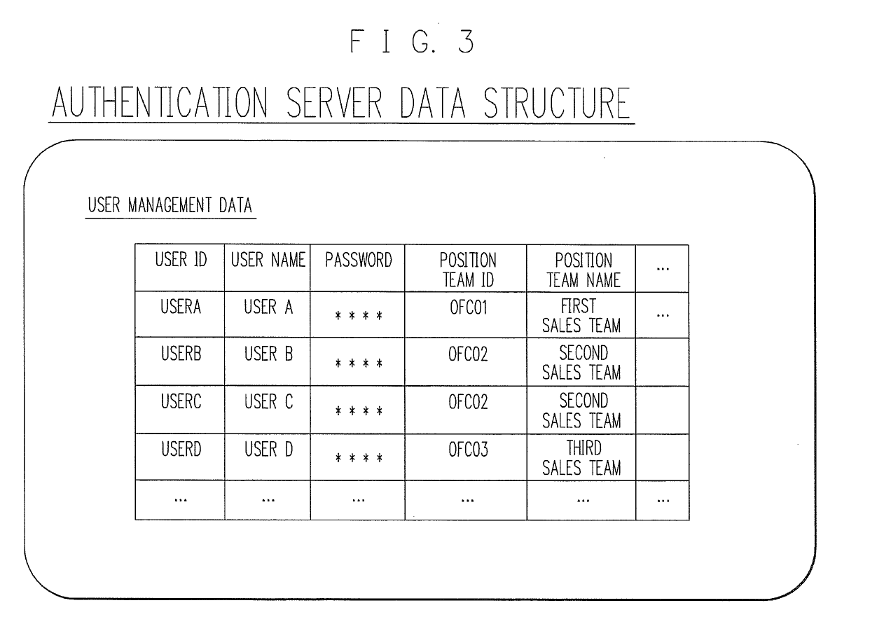

To begin with, user authentication in the authentication server 30 (upon log-in) will be described. In the authentication server 30 (UD1), a user ID of a user using the system, a user name, a password, a department ID of a department to which the user belongs, a department name of a department to which the user belongs, a group ID of a group to which the user belongs, a group name of a group to which the user belongs, and the like are registered and collectively managed in a database (DB) as the recording unit 33 that stores the user information of the authentication server 30. For example, such data as shown in FIG. 3 includes a data structure managed by the authentication server 30.

The data structure shown in FIG. 3 will be described. The row whose user ID is USERA has the user name of user A, the password of ****, the department ID of OFC01, and the department name of First sales team. The row whose user ID is USERB has the user name of user B, the password of ****, the department ID of OFC02, and the department name of Second sales team. The row whose user ID is USERC has the user name of user C, the password of ****, the department ID of OFC02, and the department name of Second sales team. The row whose user ID is USERD has the user name of user D, the password of ****, the department ID of OFC03, and the department name of Third sales team.

(Authority Check in Document Managing Server 40)

Next, authority check in the document managing server 40 will be described. A reference authority, an update authority, and a deletion authority are defined in the document managing server 40 as types of access authorities that may be set for each object such as a document, a cabinet, and the like, and a registration authority is defined in a cabinet or folder for registration to other cabinets or folders under the control of the cabinet or folder. For example, in a case where a request is made from the client terminal 10 with respect to a reference manipulation of object attribute acquisition, authority authentication is conducted on whether a user who receives the request and performs acquisition has a reference authority on the targeted object.

Each object (instance) has an unique instance ID that is automatically generated in the DB of the document managing server 40 upon registration. The instance ID is used to designate a targeted object. The instance ID is transferred from the Web server 20 to the document managing server 40 through an API along with the user personal information (IP1) in response to a request from the client terminal 10.

The one that is displayed on a list screen of the document managing system, which is displayed on the browser of the client terminal 10, is that with a reference authority which may be referred to by the log-in user.

In a case where manipulations are performed other than the reference manipulation, such as acquisition of an attribute list, update decision on the update screen, acquisition of a list under the control of a cabinet or folder, and deletion of an object, communication may be carried out from the Web server 20 to the document managing server 40.

The data structure regarding the access authority data that is stored in the access authority data maintaining unit 45 on the document managing server 40 will be described herein.

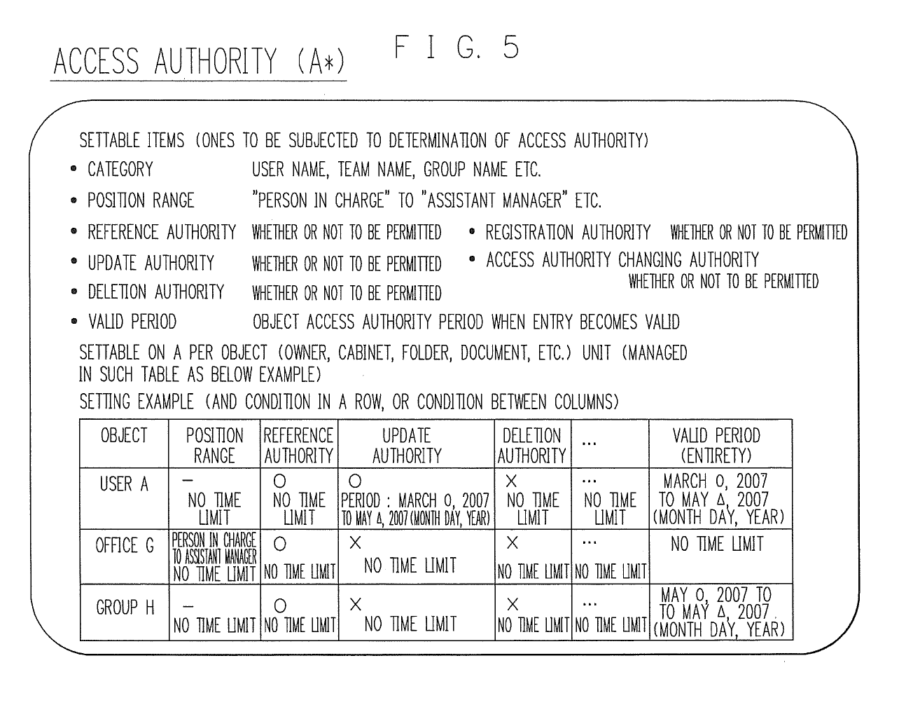

Access authority entry information, which is stored as A* herein, is stored for each object as shown in FIG. 1. The access authority information may be set in the form of a conditional equation using personal information (P*) as shown in FIG. 5. The personal information includes, for example, a name of a user, a department name of a department to which the user belongs, a position, or a group name of a group to which the user belongs. The access authority information is managed in the form of a table for each object.

The access authority information shown in FIG. 5 will be described herein. The row whose object is user A has no position range, the reference authority of ◯ and no time limit, the update authority of ◯ and Mar. ◯, 2007 (month day, year) to May Δ, 2007 (month day, year), the deletion authority of × and no time limit, and the valid period (entirety) of Mar. ◯, 2007 (month day, year) to May Δ, 2007 (month day, year). The row whose object is office G has the position range of person in charge to assistant manager and no time limit, the reference authority of ◯ and no time limit, the update authority of × and no time limit, the deletion authority of × and no time limit, and the valid period (entirety) of no time limit. The row whose object is group H has no position range, the reference authority of ◯ and no time limit, the update authority of × and no time limit, the deletion authority of × and no time limit, and the valid period (entirety) of May ◯, 2007 (month day, year) to May Δ, 2007 (month day, year).

Even though each authority value is represented as “◯” or “×” for easiness of understanding in FIG. 5, the authority value is managed as a numerical value in the DB. This is also the same for the position range.

In the access authority information, a combination of conditions of the personal information, for example, AND condition or OR condition may be available, and the access authority information may be set by combining valid periods on a per-access authority entry unit. Further, it may be possible to set the valid period as no designation, that is, to make the valid period always valid.

Further, it is possible to set a valid period for each authority in an access authority entry. In a case where a valid period for the entire authorities is set, the valid period for each authority should be set to be within the valid period for the entire authorities.

Upon authority checking, for combining the valid periods on a per-access authority entry unit, only the access authority entries within the valid period are subjected to checking. And, only the authorities within the valid period are subjected to checking in an access authority entry.

(Flow of Authority Checking Process)

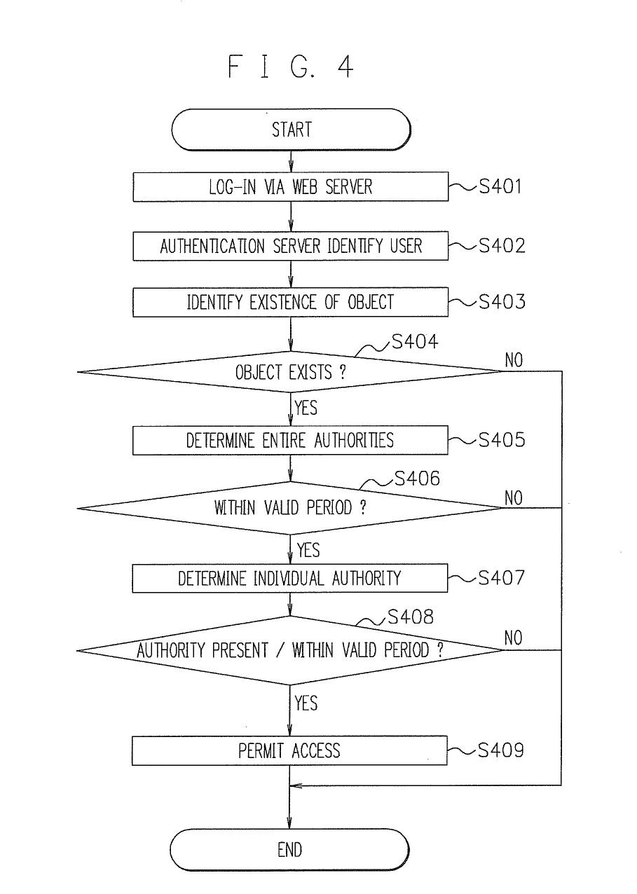

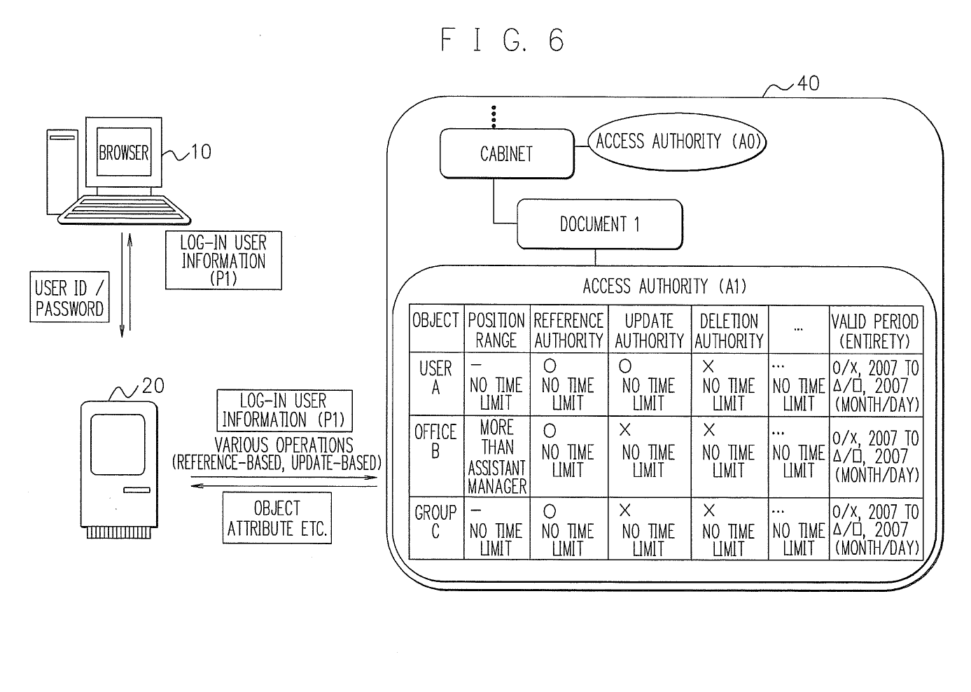

Next, a flow of the authority checking process at the document managing server 40 will be described with reference to the flowchart shown in FIG. 4. A case will be considered as an example, where the user A (P1) as shown in FIG. 6 performs reference, which is attribution acquisition, on the file “document 1”.

An aspect of the reference manipulation is performed at the client terminal 10 during displaying an object list under the control of “cabinet” and upon conducting, for example, a pressing operation of an attribute list displaying button which is a operation for referring to the detailed attribute of the “document 1”. And, the “document 1” displays only the part of the attribute in this case.

Upon log-in before the authority checking process, user authentication is conducted. The user gains access to a log-in screen of the document managing system through the browser of the client terminal 10, and enters the user ID and password to log in the system (step S401). In this case, communication is performed from the Web server 20 (API) through the communication unit 32 of the authentication server 30. In a case where authentication is normally done by the authentication unit 31 of the authentication server 30, the authentication server 30 returns the user's personal information to the Web server 20 through the communication unit 32 as an API return value and ends the authentication process (step S402).

It is assumed in FIG. 6 that an access authority such as A1 has been set to the “document 1”. Here, the access authority information will be described as shown in FIG. 6. The row whose object is user A has no position range, the reference authority of ◯ and no time limit, the update authority of ◯ and no time limit, the deletion authority of × and no time limit, and the valid period (entirety) of ◯/× (month/day), 2007 to Δ/□ (month/day), 2007. The row whose object is office B has the position range of more than an assistant manager and no time limit, the reference authority of ◯ and no time limit, the update authority of × and no time limit, the deletion authority of × and no time limit, and the valid period (entirety) of ◯/× (month/day), 2007 to Δ/□ (month/day), 2007. The row whose object is group C has no position range, the reference authority of ◯ and no time limit, the update authority of × and no time limit, the deletion authority of × and no time limit, and the valid period (entirety) of ◯/× (month/day), 2007 to Δ/□ (month/day), 2007.

In a case where the user A (P1) desires to gain access to the “document 1” to obtain the attribute list of the “document 1”, it is firstly checked whether the “document 1” designated by the instance ID exists in the DB as a target to be operated (step S403). That is, the object identifying unit 41 of the document managing server 40 checks the database that includes a predetermined table recording the access authority data of the access authority data maintaining unit 45 to see whether there exists the access-requested object.

An instance ID list which exists in the DB is collectively managed as a table in the document managing server 40, and comparison with the data in the table is carried out (step S404).

In a case where there exists in the DB the “document 1” designated by the instance ID (Yes in the step S404), an authority check is performed on whether the user A has a reference authority with respect to the “document 1” or not (step S405). That is, the entire authority checking unit 42 of the document managing server 40 determines whether each access authority entry is within a valid period or not.

First of all, the access authority information A1 of the “document 1” is acquired. Also, it has been managed <registered> in the DB as a unique attribute of the object.

At this time, the access authority entry for the user A is within the valid period (Yes in the step S406).

Next, it is sequentially determined with respect to valid access authority entries whether an authority is within the valid period or not (step S407). That is, the individual authority checking unit 43 of the document managing server 40 sequentially determines whether an individual authority is within the valid period with respect to the valid access authority entries. As a result, the valid period on the reference authority corresponds to no time limit and is always valid (Yes in the step S408).

Accordingly, it is determined that in this case the user A (P1) may refer to the “document 1”, that is, has an authority. That is, the access permitting unit 44 of the document managing server 40 permits access to the object in a case where the authority is determined to be within the valid period through the authority checking (step S409).

Thereafter, the list information of the attribute is acquired from the attribute data of the targeted object in the DB and returned to the client terminal 10. An attribute list screen is displayed on the client terminal 10.

The following utilization methods are available according to the exemplary embodiments.

It is assumed as an example that editing of a document is performed by plural specific people, and the edited document is intended to be not laid open to general users at the registration time of the document but laid open department or company wide after a week later. The access authority entries are set to start to be open a week after the registration date as a valid time limit with respect to general users to whom the document will be open. And, the document may be not referred to by the general users until the opening start date lapses by granting a valid access authority to only the users who will perform a certain editing process, so that only the users who will perform the editing process may edit the document.

Also, if the opening start date lapses with respect to the general users to which the document is open, the access authority automatically becomes valid, and if the opening end date lapses, the access authority automatically becomes invalid. As such, it becomes possible to automatically grant an access authority to a specific user within a certain period.

Also, in an aspect where a document is laid open once and then edited to be reopened, it is possible to grant permission of access to specified general users only not by resetting the access authority but by changing only the valid period of a corresponding access authority entry, and this leads to alleviation of operator's loads. That is, it becomes unnecessary to reset the access authority that has been performed by the users because it is possible to change the invalid state, in which the period has been terminated, to a valid state again only by changing the value of the valid period.

Further, it is also possible to support a function of collectively changing plural access authority entries into the same period, and such collective changing of the whole access authority entries makes it possible to perform control corresponding to the “display period” attribute.

Moreover, since the present invention may additively set a valid period for each authority in one access authority entry, and this enables control an authority range to have a valid period even with respect of the same object.

In the present invention, access authority information includes an object, a position range, designation of presence or absence of each authority, and a valid period on a per entry unit, and the document managing server 40 determines whether or not an access authority for accessing a document under its management satisfies conditions on the object, the position range, the presence or absence of each authority, and the valid period preset on a per entry unit when receiving an access request for accessing the document from the client terminal 10, and permits access to the document when the whole conditions are satisfied. This enables expand the width of conditions that may be set as the access authority, thus making it possible to perform access control corresponding to diversified use aspects.

Further, the exemplary embodiments are merely preferred exemplary embodiments of the present invention, and therefore, a diversity of variations of the present invention may be made without departing from the spirit of the present invention. For example, it may be possible to implement the function of each device by executing programs, each of which realizes the function of each of the client terminal 10, the Web server 20, the authentication server 30, and the document managing server 40. And, the program may be transmitted to other computer systems through a computer-readable recording medium, such as CD-ROMs or optical magnetic disks, or through a transmission medium such as the Internet or telephone lines in the form of transmission waves. Moreover, it also falls within the range of the present invention that the function of each device is implemented together by other devices or the function is dispersedly realized by an additional device.

As an effect of the present invention, it becomes unnecessary to reset the access authority entries. Moreover, since the access authority automatically becomes valid/invalid when the period arrives on a per preset access authority entry unit, automatic access control on some users only as well as flexible access control according to each use aspect can be performed.

What is claimed is:

1. A document managing system having a document managing server and a client terminal that are connected to each other via a network, wherein
the document managing server determines whether or not an access authority for accessing a document under its management is within a valid period preset on a per entry unit when receiving an access request for accessing the document from the client terminal, and permits access to the document when the access authority is within the valid period.

2. The document managing system according to claim 1, wherein the valid period preset on a per entry unit is set for each and every authority in one entry.

3. The document managing system according to claim 1, wherein access authority information includes an object, a position range, designation of presence or absence of each authority, and a valid period on a per entry unit, wherein
the document managing server determines whether or not an access authority for accessing a document under its management satisfies conditions on the object, the position range, the presence or absence of each authority, and the valid period preset on a per entry unit when receiving an access request for accessing the document from the client terminal, and permits access to the document when the whole conditions are satisfied.

4. The document managing system according to claim 1, wherein the valid period preset on a per entry unit is changed into a same period value based on an access authority changing authority collectively with respect to plural entries.

5. The document managing system according to claim 1, wherein information of the access authority is set for the overall objects.

6. An information processing device determining whether or not an access authority for accessing a document is within a valid period preset on a per entry unit when receiving an access request for accessing the document, and permits access to the document when the access authority is within the valid period.

7. The information processing device according to claim 6, wherein the valid period preset on a per entry unit is set for each and every authority in one entry.

8. The information processing device according to claim 6, wherein access authority information includes an object, a position range, designation of presence or absence of each authority, and a valid period on a per entry unit, wherein
the information processing device determines whether or not an access authority for accessing a document satisfies conditions on the object, the position range, the presence or absence of each authority, and the valid period preset on a per entry unit when receiving an access request for accessing the document, and permits access to the document when the whole conditions are satisfied.

9. The information processing device according to claim 6, wherein the valid period preset on a per entry unit is changed into a same period value based on an access authority changing authority collectively with respect to plural entries.

10. The document processing device according to claim 6, wherein information of the access authority is set for the overall objects.

11. A document managing method comprising:
receiving an access request for accessing a document;
determining whether or not an access authority for accessing the document is within a valid period preset on a per entry unit; and
permitting access to the document if the access authority is within the valid period.

12. The document managing method according to claim 11, wherein the valid period preset on a per entry unit is set for each and every authority in one entry.

13. The document managing method according to claim 11, wherein access authority information includes an object, a position range, designation of presence or absence of each authority, and a valid period on a per entry unit, wherein
the document managing method determines whether or not an access authority for accessing a document satisfies conditions on the object, the position range, the presence or absence of each authority, and the valid period on a per entry unit when receiving an access request for accessing the document, and permits access to the document when the whole conditions are satisfied.

14. The document managing method according to claim 11, further comprising:
changing the valid period preset on a per entry unit into a same period value based on an access authority changing authority collectively with respect to plural entries.

15. The document managing method according to claim 11, wherein information of the access authority is set for the overall objects.

16. A storage medium for storing program causes an information processing device to execute process including:
receiving an access request for accessing a document;
determining whether or not an access authority for accessing the document is within a valid period preset on a per entry unit; and
permitting access to the document if the access authority is within the valid period.

17. The storage medium for storing the program according to claim 16, wherein the valid period preset on a per entry unit is set for each and every authority in one entry.

18. The storage medium for storing the program according to claim 16, wherein access authority information includes an object, a position range, designation of presence or absence of each authority, and a valid period on a per entry unit, wherein
the program executing determining whether or not an access authority for accessing a document satisfies conditions on the object, the position range, the presence or absence of each authority, and the valid period preset on a per entry unit when receiving an access request for accessing the document, and permitting access to the document when the whole conditions are satisfied.

19. The storage medium for storing the program according to claim 16, further executing changing the valid period preset on a per entry unit into a same period value based on an access authority changing authority collectively with respect to plural entries.

20. The storage medium for storing the program according to claim 16, wherein information of the access authority is set for the overall objects.
